(19) United States
(12) Patent Application Publication
(10) Pub. No.: US 2018/0022357 A1
(43) Pub. Date: Jan. 25, 2018

(54) DRIVING RECORDER SYSTEM

(71) Applicant: Panasonic Automotive Systems Company of America, Division of Panasonic Corporation of North America, Peachtree City, GA (US)

(72) Inventors: TOSHIHIKO MORI, SUNNYVALE, CA (US); YASUHIRO TSUCHIDA, OSAKA (JP)

(73) Assignee: Panasonic Automotive Systems Company of America, Division of Panasonic Corporation of North America

(21) Appl. No.: 15/654,052

(22) Filed: Jul. 19, 2017

Related U.S. Application Data
(60) Provisional application No. 62/364,251, filed on Jul. 19, 2016.

(51) Int. Cl. B60W 40/08; G08B 21/02; G06T 5/50; B60K 28/02; G07C 5/08; G06K 9/00

(52) U.S. Cl. CPC B60W 40/08; G07C 5/085; G06K 9/00791; G06T 5/50; B60K 28/02; G08B 21/02

(57) ABSTRACT

A safety level indication arrangement for a motor vehicle includes a first camera capturing first images of an environment surrounding the motor vehicle. A second camera captures second images of a driver of the motor vehicle. A microphone is associated with the passenger compartment and produces a microphone signal dependent upon sounds within the passenger compartment. At least one vehicle sensor detects an operational parameter of the motor vehicle. A display device is associated with the passenger compartment. A loudspeaker is associated with the passenger compartment. An electronic processor ascertains a safety level based on the first images and the operational parameter of the motor vehicle. The electronic processor determines how to present the ascertained safety level to the driver by use of the display device and/or the loudspeaker. The determining is dependent upon the second images and the microphone signal.

### CROSS-REFERENCED TO RELATED APPLICATIONS

This application claims benefit of U.S. Provisional Application No. 62/364,251 filed on Jul. 19, 2016, which the disclosure of which is hereby incorporated by reference in its entirety for all purposes.

### FIELD OF THE INVENTION

The disclosure relates to a safety system for use in a motor vehicle, and, more particularly, to a system for providing safety-related information to a driver.

### BACKGROUND OF THE INVENTION

Known driving recorders, such as driving recorder apps for smartphones, utilize recorded movies or videos to provide information to the driver by recognizing the road situation in the movie and presenting a notification/indication to the driver about how to drive safely. These known driving recorders are good for making drivers feel comfortable, although they have no consideration of what/how to provide the notification/indication to the driver. For example, known driving recorders may merely display a “danger” mark on the smartphone screen in spite of the driver not looking at the screen. Alternatively, known driving recorders may play a caution sound in spite of the driver playing music loudly. Known driving recorders may also display a vivid color “caution” sign along with playing a loud sound in spite of it being very silent in the car and it being night time, and thus a disturbing level of stimuli may be provided.

Known driving recorders may record video evidence of accidents that the vehicle is involved in by capturing video of the driving scene when the accident happens. However, accidents occur very rarely, so the video that a driving recorder captures is immediately discarded in almost all situations.

### SUMMARY

The present invention may provide a driving recorder system which stores and analyzes driving data, calculates a safety level, and notifies the driver about the calculated safety level with an output method that depends upon the current car environment and the status of the driver's attention. The inventive driving recording system may select an effective action to notify the driver of the current safety level, such as displaying a notice, playing a sound, or controlling an actuator, for example. If the vehicle is operating in a very noisy environment or during daylight hours, then a red safety alert mark may be displayed on the screen. However, if the vehicle is operating in a silent environment or during nighttime hours, then an alert sound is audibly played. These above two cases are very simple ones. However, in actuality, what is displayed or audibly played, or how it is displayed or audibly played, is determined based upon several presentation effectiveness factors.

By utilizing the captured movie data, the inventive driving recording system may make drivers feel more relaxed, comfortable and safe due to some novel features. The inventive driving recording system may evaluate the safety level of the driving situation by detecting surrounding cars, and, for example, determining how far away the surrounding cars are; by analyzing videos captured in real time; and by utilizing braking/steering information (e.g., from an accelerometer/gyroscope), speed information (e.g., from a global positioning system—GPS) and road congestion information (e.g., from a GPS and/or the cloud).

The inventive driving recording system may analyze the driver's condition by detecting the driver's face, the direction in which his eyes are looking, and/or the number of times he blinks within a certain time period. The overall safety level may then be calculated based on the above two factors, i.e., the safety level of the driving situation and the driver's condition.

The inventive driving recording system may calculate an effective action vector which includes parameters to determine what should be presented to the driver and how it should be presented (e.g., via a visual display or an audible sound). Thus, the inventive driving recording system may notify the driver of the safety level more effectively and more safely by detecting the environmental situation (e.g., noise level, brightness, . . . ), and by ascertaining what the driver's attention is focused on.

In one embodiment, the invention comprises a safety level indication arrangement for a motor vehicle, including a first camera capturing first images of an environment surrounding the motor vehicle. A second camera captures second images of a driver of the motor vehicle within a passenger compartment of the motor vehicle. A microphone is associated with the passenger compartment and produces a microphone signal dependent upon sounds within the passenger compartment. At least one vehicle sensor detects an operational parameter of the motor vehicle. A display device is associated with the passenger compartment. A loudspeaker is associated with the passenger compartment. An electronic processor is communicatively coupled to the first camera, the second camera, the microphone, the vehicle sensor, the display device, and the loudspeaker. The electronic processor ascertains a safety level based on the first images and the operational parameter of the motor vehicle. The electronic processor determines how to present the ascertained safety level to the driver by use of the display device and/or the loudspeaker. The determining is dependent upon the second images and the microphone signal.

In another embodiment, the invention comprises a method of notifying an operator of a motor vehicle of a safety status, including capturing first images of an environment surrounding the motor vehicle. Second images of a driver of the motor vehicle within a passenger compartment of the motor vehicle are captured. A microphone signal is produced dependent upon sounds within the passenger compartment. An operational parameter of the motor vehicle is detected. A safety level is ascertained based on the first images and the operational parameter of the motor vehicle. It is determined how to present the ascertained safety level to the driver by use of a display device and/or a loudspeaker dependent upon the second images and the microphone signal.

In yet another embodiment, the invention comprises a safety level presentation arrangement for a motor vehicle, including a camera capturing images of a driver of the motor vehicle within a passenger compartment of the motor vehicle. A microphone is associated with the passenger compartment and produces a microphone signal dependent upon sounds within the passenger compartment. A display device is associated with the passenger compartment. A loudspeaker is associated with the passenger compartment. An electronic processor is communicatively coupled to the camera, the microphone, the display device, and the loudspeaker. The electronic processor ascertains a safety level based on the images and traffic information wirelessly received from an external source. The electronic processor determines how to present the ascertained safety level to the driver by use of the display device and/or the loudspeaker dependent upon the images and the microphone signal.

### BRIEF DESCRIPTION OF THE DRAWINGS

A better understanding of the present invention will be had upon reference to the following description in conjunction with the accompanying drawings.

FIG. 1 is a block diagram of one example embodiment of a driving recorder system of the present invention.

FIG. 2 is a block diagram of another example embodiment of a driving recorder system of the present invention.

FIG. 3 is a schematic view of one example embodiment of the driving recorder of the driving recorder system of FIG. 2.

FIG. 4 is a perspective view of the driving recorder and smartphone of the driving recorder system of FIG. 2 installed in a motor vehicle.

FIG. 5 is a flow chart of one embodiment of a driving recording method of the present invention.

FIG. 6 is an example image captured by the forward-facing camera of the driving recorder of the driving recorder system of FIG. 2.

FIG. 7 is an example image captured by the rearward-facing camera of the driving recorder of the driving recorder system of FIG. 2.

FIG. 8 is a flow chart of one embodiment of a method of effective action selection of the present invention.

FIG. 9 is one embodiment of a covariance matrix table which may be used in the method of FIG. 8.

FIG. 10 is a schematic diagram of the mapping of the present invention from a vector of current brightness, noise, and driver's attention to a converted vector of how the safety notice is presented to the driver.

FIG. 11 is a flow chart of one embodiment of a method of the present invention for notifying an operator of a motor vehicle of a safety status.

### DETAILED DESCRIPTION OF THE PREFERRED EMBODIMENTS

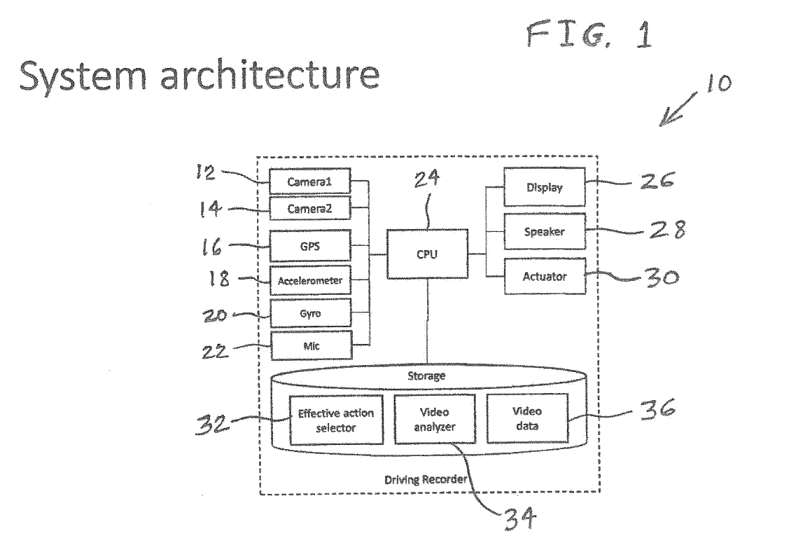

FIG. 1 illustrates an example embodiment of a driving recorder system 10 of the present invention, including cameras 12, 14, a GPS module 16, an accelerometer 18, a gyroscope 20, a microphone 22, a central processing unit (CPU) 24, a display screen 26, a loudspeaker 28, an actuator 30, an effective action selector 32, a video analyzer 34, and a video data storage device 36.

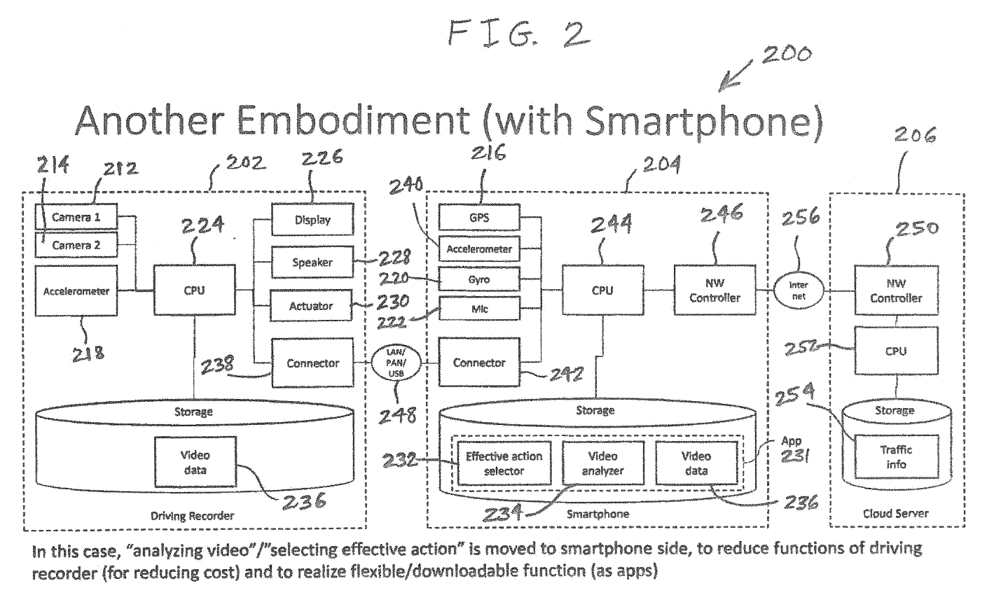

FIG. 2 illustrates another example embodiment of a driving recorder system 200 of the present invention, including a driving recorder 202, a smartphone 204, and a cloud server 206. Driving recorder 202 includes cameras 212, 214, an accelerometer 218, a central processing unit (CPU) 224, a display screen 226, a loudspeaker 228, an actuator 230, a connector 238, and a video data storage device 236.

Smartphone 204 includes a GPS module 216, an accelerometer 240, a gyroscope 220, a microphone 222, a connector 242, a CPU 244, a NW controller 246, and an app 231 including an effective action selector 232, a video analyzer 234, and a video data storage 236. Connectors 238, 242 are in communication with each other via a local area network (LAN), personal area network (PAN), or a universal serial bus (USB) 248.

Cloud server 206 includes a NW controller 250, a CPU 252, and a traffic information storage device 254. NW controllers 246, 250 are in communication with each other via internet 256. Driving recorder system 200, as opposed to driving recorder system 10, analyzes video and selects effective action in a smartphone, thereby reducing the functions of the driving recorder and the cost of the driving recorder. Driving recorder system 200 also thereby realizes flexible/downloadable function as apps in the smartphone.

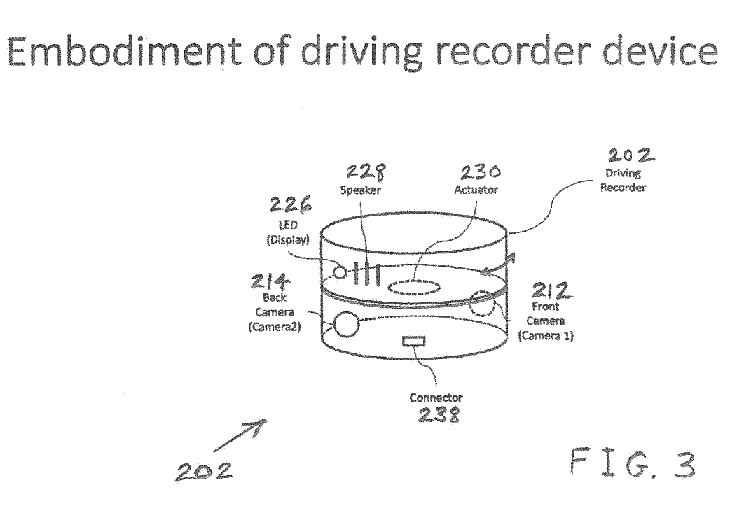

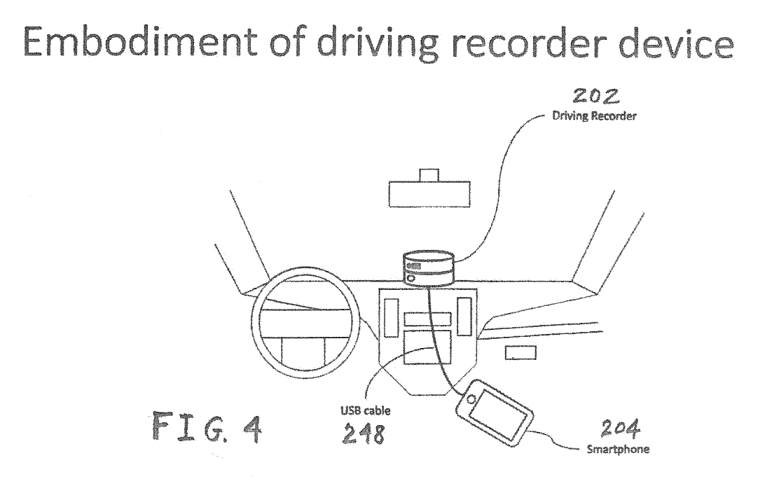

FIG. 3 illustrates driving recorder 202 of driving recorder system 200. FIG. 4 illustrates driving recorder 202 and smartphone 204 of driving recorder system 200 installed in a motor vehicle.

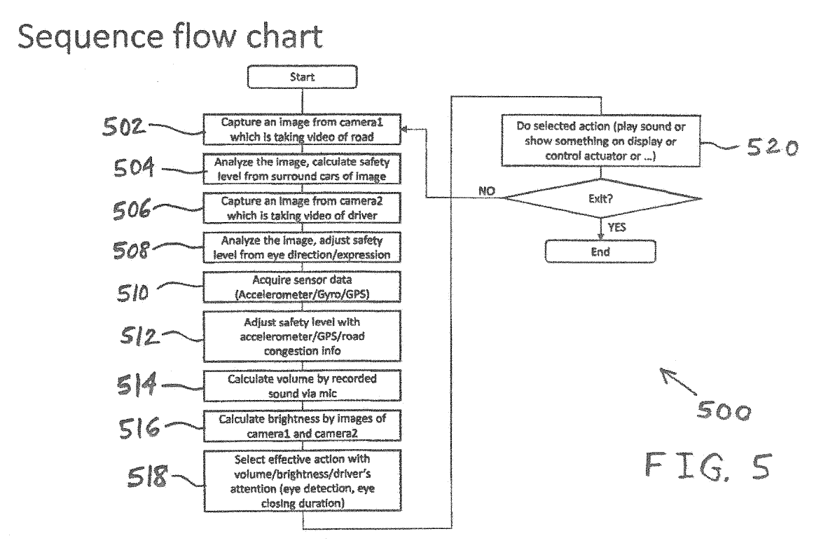

FIG. 5 is a flow chart of one embodiment of a driving recording method 500 of the present invention. In a first step 502, front-facing camera 212 captures an image while taking video of the road that the driver's motor vehicle is driving on. In step 504, the image is analyzed, and a safety level is calculated based on the surrounding vehicles in the image. For example, a numerical safety level may be calculated based upon the number of vehicles, the direction of the vehicles relative to the driver's vehicle, and the distances between the vehicles and the driver's vehicle.

Next, in step 506, rear-facing camera 214 captures an image while taking video of the driver's face while he is driving. In step 508, the image is analyzed, and the safety level calculated in step 504 is adjusted based on the direction in which the driver is looking, and/or based on the driver's facial expression. For example, the safety level may be adjusted downward if the driver is not looking at the road, has his eyes closed, is blinking excessively, or if the driver's face indicates that the driver is in an extreme emotional state, such as angry, crying, or jubilant.

In step 510, sensor data is acquired. For example, data may be received from accelerometers 218, 240, GPS 216 and gyroscope 220. Next, step 512, the safety level is again adjusted based on inputs from accelerometers 218, 240, GPS 216 and road congestion information, which may be received wirelessly via the internet. For example, the safety level may be adjusted downward if the accelerometers indicate that the driver's vehicle is accelerating or de-accelerating at a high rate, if the GPS indicates that the driver's vehicle is off the road or is traveling significantly above or below the speed limit, or if the vehicle is traveling in heavy traffic.

In step 514, the sound volume level within the passenger compartment of the driver's vehicle is determined based upon microphone signals produced by microphone 222. Next, in step 516, the brightness level within the passenger compartment of the driver's vehicle is determined based upon images captured by cameras 212, 214. In step 518, an effective way to present the safety level to the driver is selected based upon the volume and brightness levels in the passenger compartment, as well as on what the driver is currently paying attention to, as determined from eye detection (e.g., the driver's detected eye movements and how long the time periods are in which his eyes are closed). For example, the safety level may be visually presented to the driver if it is loud in the passenger compartment. The luminance of the safety level display may be greater if there is a lot of light within the passenger compartment. The presentation of the safety level may be louder and brighter, and/or the activation of the actuator may be more frequent if eye detection indicates that the driver is not paying sufficient attention to the driving task. In a final step 520, the selected action is performed. That is, a sound is played, something is presented on a display screen, and/or an actuator is controlled in order to indicate the safety level to the driver. Method 500 may then be ended or may be repeated as many times as the driver continues to drive.

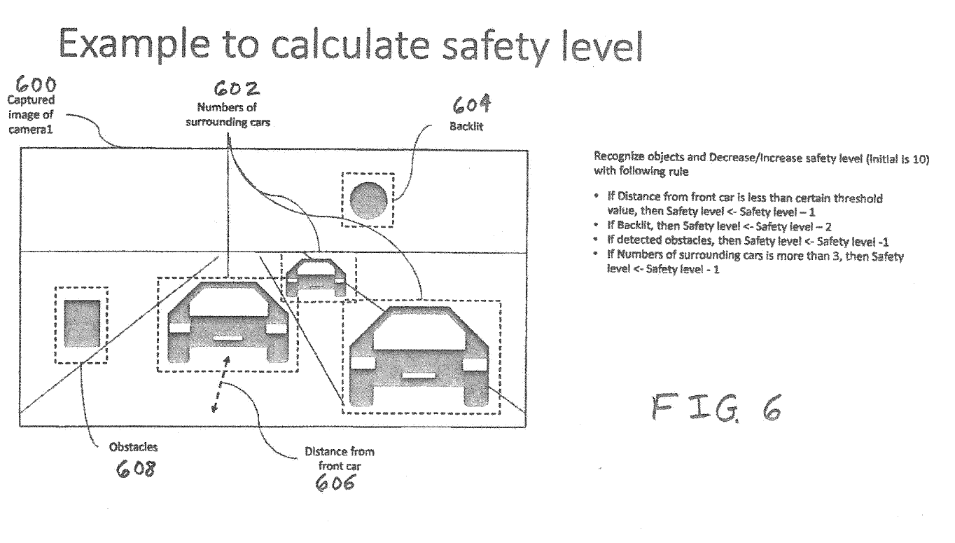

FIG. 6 is an example image 600 captured by forward-facing camera 212. CPU 224 and/or CPU 244 may analyze image 600 and determine therefrom the number of vehicles 602 surrounding the driver's vehicle, which is three in this example. CPU 224 and/or CPU 244 may also determine from image 600 whether the road scene that the driver is looking at is backlit, e.g., whether the sun 604 is generally behind what the driver is looking at. CPU 224 and/or CPU 244 may further determine from image 600 a distance 606 between the driver's vehicle and any other vehicle within image 600. Finally, CPU 224 and/or CPU 244 may determine from image 600 the locations and number of obstacles 608 within image 600.

In one embodiment, the safety level begins at a perfect safety score, such as ten, and is decreased various amounts for each factor that is present in image 600 and that tends to lessen safety. For example, if the distance between the driver's car and any other car is less than a threshold value, then the safety level may be reduced by one; if the scene that the driver is looking at is backlit, then the safety level may be reduced by two; if an obstacle is detected, then the safety level may be reduced by one; and if the number of surrounding cars is more than three, then the safety level may be reduced by one. Thus, if the scene is backlit, and there are four surrounding vehicles, but there are no other unsafe factors present, then the safety level would be calculated as seven.

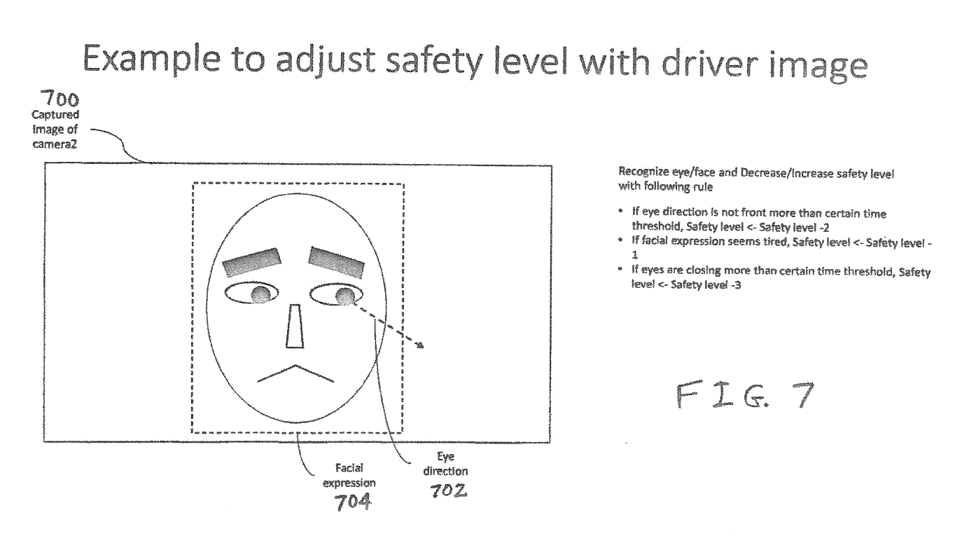

FIG. 7 is an example image 700 captured by rearward-facing camera 214. CPU 224 and/or CPU 244 may analyze image 700 and determine therefrom the direction 702 in which the driver's eyes are looking. CPU 224 and/or CPU 244 may also determine from image 700 the facial expression 704 of the driver, e.g., whether the driver looks angry, fatigued, etc.

In one embodiment, an initial safety score is taken over from a safety score calculating procedure based on factors outside of the car, as shown by FIG. 6, or performed outside of the car. The safety level may begin at a perfect safety score, such as ten, and is decreased various amounts for each factor that is present in image 700 and that tends to lessen safety. For example, if the driver looks away from the road for more than a threshold period of time, or if the driver does not look forward at the road for more than a threshold period of time, then the safety level may be reduced by two; if the driver's facial expression indicates that he is tired, then the safety level may be reduced by one; and if the driver closes his eyes for longer than a threshold period of time, then the safety level may be reduced by three. Thus, if the driver's facial expression indicates that he is tired and if the driver closes his eyes for longer than a threshold period of time, but there are no other unsafe factors present, then the safety level would be calculated as three, if the initial safety score is seven.

The numeric safety level may also be adjusted based on sensor/cloud data. The sensor data may be received from the accelerometer, gyroscope, and/or GPS, for example. Traffic congestion data may be received from the cloud. The numeric safety level may be decreased or increased by use of the following example rules.

The numeric safety level may start out at a value of ten, and may be reduced therefrom based upon the presence of various conditions that tend to reduce safety. If the speed of the driver's vehicle exceeds the speed limit, then the safety level may be reduced by two. If the speed of the driver's vehicle is intensively up or down (e.g., high acceleration or de-acceleration, as with sudden braking), then the safety level may be reduced by one. If the angle speed is intensively changed (e.g., the vehicle's heading direction changes quickly, combined with relatively high speed, as with sudden handling), then the safety level may be reduced by one. If the road that the driver's vehicle is traveling on is very congested (e.g., there is a traffic jam), then the safety level may be reduced by one.

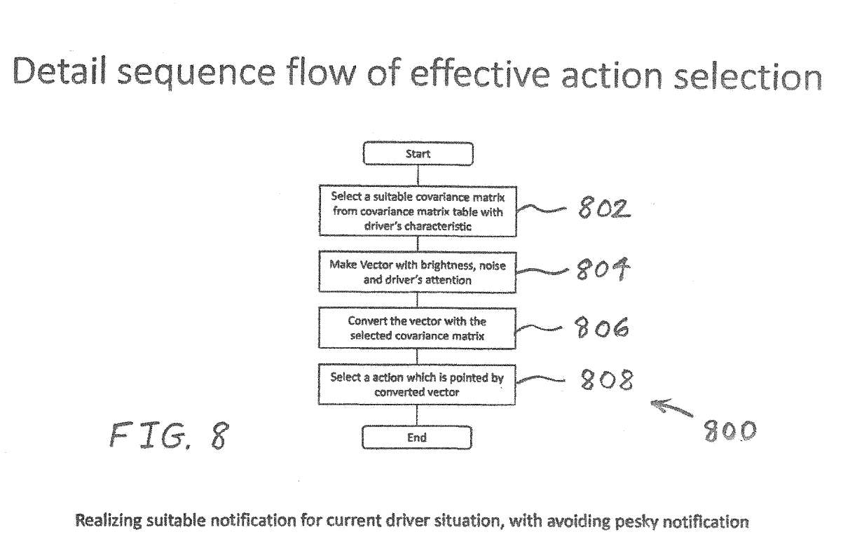

FIG. 8 illustrates one embodiment of a method 800 of the present invention for selecting an effective way of presenting a safety notification to the driver. This may be according to the detailed procedure of step 518. Method 800 may enable the realization of a notification that is suitable in view of the current driver situation, while avoiding providing pesky safety notifications whose information is not worth the driver distraction that they cause.

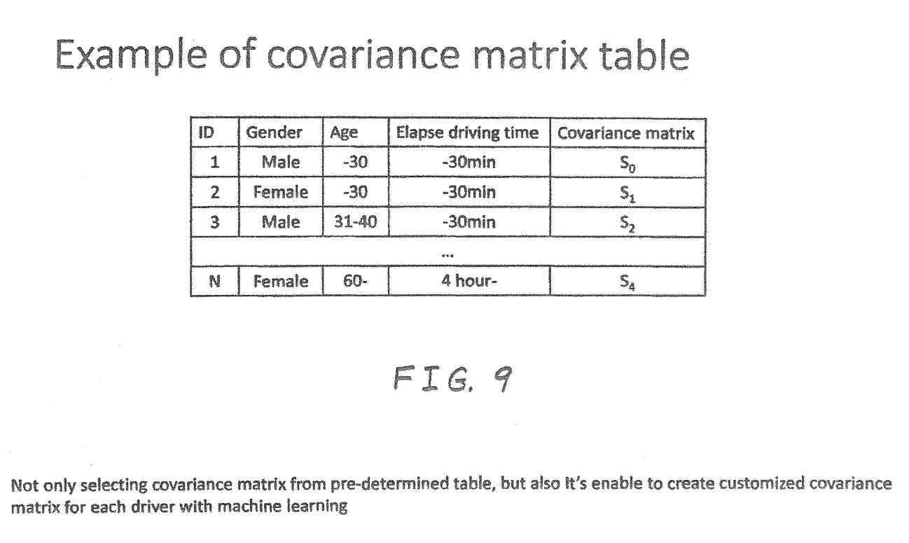

In a first step 802, a suitable covariance matrix is selected, based on the driver's characteristics and how long the driver has been driving during the current trip, from a covariance matrix table, an example of which is shown in FIG. 9. For example, as shown by identification number 3 in the covariance matrix table of FIG. 9, a covariance matrix labeled “S₂” may be applied to a male driver between the ages of 31 and 40 years old, and who has been driving during the current trip for less than 30 minutes. In general, a covariance matrix may define, for a particular type of driver who has been driving uninterrupted for a particular period of time, the frequency and medium (e.g., audio, video, actuator) by which the safety level indication is presented to the driver, depending upon how noisy and bright the driving environment is, and depending upon the driver's perceived emotional state and how much attention the driver is paying to the driving task. Although the covariance matrix may be selected from the predetermined table of FIG. 9, it is also possible within the scope of the invention to create a customized covariance matrix for each driver by use of machine learning.

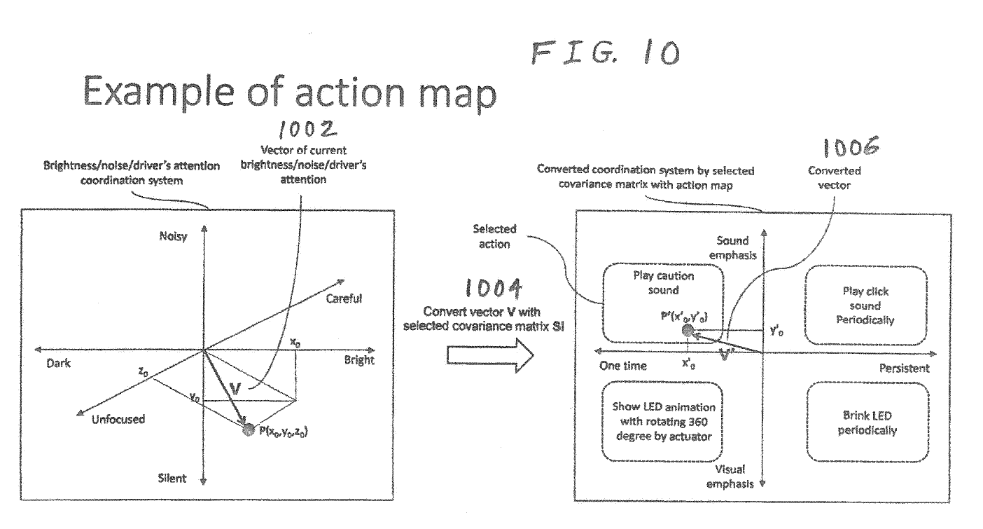

In a next step 804, a vector is determined reflecting the brightness and noise level within the driver's vehicle, and reflecting the level of care and focus with which the driver appears to be driving his vehicle. For example, a three-dimensional vector 1002 (FIG. 10) is created reflecting the brightness and noise within the passenger compartment as well as a value specifying how careful and focused the driver is being.

In this case, vector 1002 is three-dimensional, although a four- or more dimensional vector can be applied. The four- or more dimensional vector may be translated into a two-dimensional vector with a covariance matrix, selected as described above. This method may be utilized to select a suitable output of vision and sound from very complex factors (e.g., a four- or more dimensional vector).

Next, in step 806, the vector determined in step 804 is converted by use of the covariance matrix selected in step 802. For example, as indicated at 1004 in FIG. 10, vector 1002 may be converted by use of selected covariance matrix Sᵢ into vector 1006. Because vector 1002 indicates a passenger compartment that is more silent than noisy, and more bright than dark, the covariance matrix may cause vector 1006 to emphasize sound more than visual aspects of the safety notification. Although generally the unfocused condition of the driver as indicated by vector 1002 would result in the safety indication being more persistent than singular, the covariance matrix may call for the safety indication to be more singular than persistent, as indicated by vector 1006, for the particular type of driver who has been driving uninterrupted for a particular span of time. Vector 1006 calls for the playing of a caution sound, but if vector 1006 were to call for emphasizing more sound than visual, and more persistent than singular, then vector 1006 may call for playing a click sound periodically. If vector 1006 were to call for emphasizing more visual than sound, and more singular than persistent, then vector 1006 may call for showing the driver an LED animation with 360-degree rotation by an actuator. Finally, if vector 1006 were to call for emphasizing more visual than sound, and more persistent than singular, then vector 1006 may call for periodically blinking an LED ON and OFF.

In a final step 808, an action is selected which is pointed to by converted vector 1006. That is, in the example of FIG. 10, the action of playing a caution sound, which is pointed to by converted vector 1006, is selected.

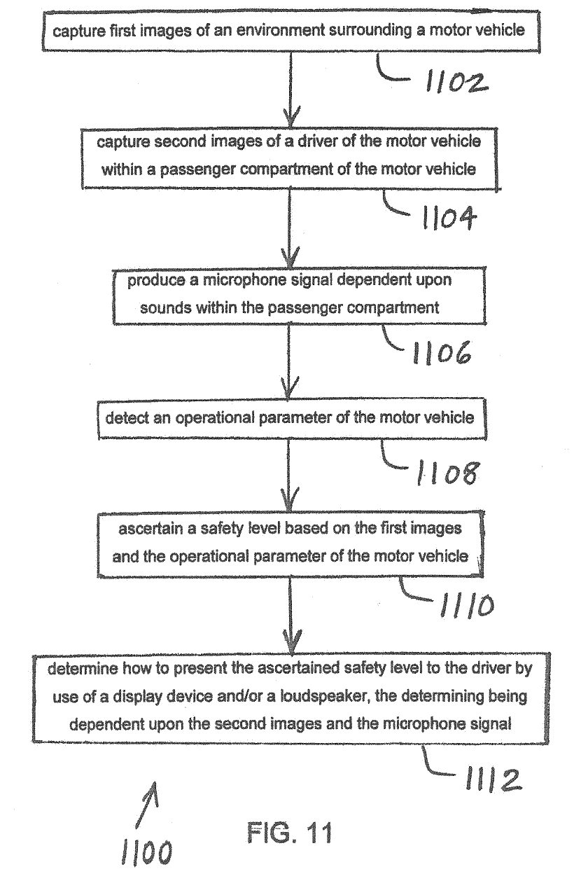

FIG. 11 illustrates one embodiment of a method 1100 of the present invention for notifying an operator of a motor vehicle of a safety status. In a first step 1102, first images of an environment surrounding the motor vehicle are captured. For example, FIG. 6 is an image 600 which may be captured by forward-facing camera 212 of an environment surrounding the operator's vehicle.

Next, in step 1104, second images of a driver of the motor vehicle within a passenger compartment of the motor vehicle are captured. For example, FIG. 7 is an example image 700 of a driver of the motor vehicle within a passenger compartment of the motor vehicle. Image 700 may be captured by rearward-facing camera 214.

In a next step 1106, a microphone signal is produced dependent upon sounds within the passenger compartment. For example, microphone 22 may produce microphone signal based upon sounds captured within the passenger compartment of a vehicle.

In step 1108, an operational parameter of the motor vehicle is detected. For example, accelerometers 218, 240 may detect that the driver's vehicle is accelerating or de-accelerating at a high rate. As another example, GPS 216 may detect that the driver's vehicle is traveling significantly above or below the speed limit.

Next, in step 1110, a safety level is ascertained based on the first images and the operational parameter of the motor vehicle. For example, the safety level may be lowered from a starting value if there are a large number of other vehicles surrounding the user's vehicle, and if the user's vehicle's speed is above a first threshold value or below a second threshold value.

In a final step 1112, how to present the ascertained safety level to the driver by use of a display device and/or a loudspeaker is determined. The determining is dependent upon the second images and the microphone signal. For example, CPU 224 and/or CPU 244 may analyze image 700 and determine therefrom the direction 702 in which the driver's eyes are looking. CPU 224 and/or CPU 244 may also determine from image 700 the facial expression 704 of the driver, e.g., whether the driver looks angry, fatigued, etc. If the driver is looking toward the display device, then the ascertained safety level may be more likely to be presented on display device 226 than audibly played on speaker 228. However, if the microphone signal indicates that the passenger compartment is quiet, then the ascertained safety level may be more likely to be audibly played on speaker 228 than presented on display device 226.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A safety level indication arrangement for a motor vehicle, comprising:
a first camera configured to capture first images of an environment surrounding the motor vehicle;
a second camera configured to capture second images of a driver of the motor vehicle within a passenger compartment of the motor vehicle;
a microphone associated with the passenger compartment and configured to produce a microphone signal dependent upon sounds within the passenger compartment;
at least one vehicle sensor configured to detect an operational parameter of the motor vehicle;
a display device associated with the passenger compartment;
a loudspeaker associated with the passenger compartment; and
an electronic processor communicatively coupled to the first camera, the second camera, the microphone, the vehicle sensor, the display device, and the loudspeaker, the electronic processor being configured to:
ascertain a safety level based on the first images and the operational parameter of the motor vehicle; and
determine how to present the ascertained safety level to the driver by use of the display device and/or the loudspeaker, the determining being dependent upon the second images and the microphone signal.

2. The arrangement of claim 1 further comprising an actuator associated with the passenger compartment, the electronic processor being configured to determine how to present the ascertained safety level to the driver by use of the display screen, the loudspeaker and/or the actuator.

3. The arrangement of claim 1 wherein the at least one vehicle sensor includes a GPS, an accelerometer and/or a gyroscope.

4. The arrangement of claim 1 wherein the electronic processor is configured to determine how to present the ascertained safety level to the driver dependent upon a brightness level in the passenger compartment as indicated by the second images.

5. The arrangement of claim 1 wherein the electronic processor is configured to determine how to present the ascertained safety level to the driver dependent upon how much attention the driver is paying to the driving task as indicated by the second images.

6. The arrangement of claim 1 wherein the electronic processor is configured to determine how to present the ascertained safety level to the driver dependent upon an emotional state of the driver as indicated by the second images.

7. The arrangement of claim 1 wherein the electronic processor is configured to determine how to present the ascertained safety level to the driver dependent upon a level of fatigue of the driver as indicated by the second images.

8. The arrangement of claim 1 wherein the electronic processor is configured to determine how to present the ascertained safety level to the driver dependent upon an age of the driver, a sex of the driver, and how long the driver has been driving uninterrupted during a current trip by the motor vehicle.

9. The arrangement of claim 1 wherein the electronic processor is configured to determine how to present the ascertained safety level to the driver dependent upon an audio volume level within the passenger compartment as indicated by the microphone signal.

10. The arrangement of claim 1 wherein the processor is configured to ascertain the safety level based on a number of surrounding vehicles in the first images, a distance between at least one of the surrounding vehicles and the motor vehicle in the first images, whether the scene in the first images is backlit, locations of obstacles in the first images, and/or a number of obstacles in the first images.

11. A method of notifying an operator of a motor vehicle of a safety status, the method comprising:
capturing first images of an environment surrounding the motor vehicle;
capturing second images of a driver of the motor vehicle within a passenger compartment of the motor vehicle;
producing a microphone signal dependent upon sounds within the passenger compartment;
detecting an operational parameter of the motor vehicle;
ascertaining a safety level based on the first images and the operational parameter of the motor vehicle; and
determining how to present the ascertained safety level to the driver by use of a display device and/or a loudspeaker, the determining being dependent upon the second images and the microphone signal.

12. The method of claim 11 wherein the determining comprises determining how to present the ascertained safety level to the driver by use of the display screen, the loudspeaker and/or an actuator.

13. The method of claim 11 wherein the determining comprises determining how to present the ascertained safety level to the driver dependent upon how much attention the driver is paying to the driving task as indicated by the second images.

14. The method of claim 11 wherein the determining comprises determining how to present the ascertained safety level to the driver dependent upon an emotional state of the driver as indicated by the second images.

15. The method of claim 11 wherein the determining comprises determining how to present the ascertained safety level to the driver dependent upon a level of fatigue of the driver as indicated by the second images.

16. The method of claim 11 wherein the determining comprises determining how to present the ascertained safety level to the driver dependent upon an age of the driver, a sex of the driver, and how long the driver has been driving uninterrupted during a current trip by the motor vehicle.

17. The method of claim 11 wherein the determining comprises determining how to present the ascertained safety level to the driver dependent upon an audio volume level within the passenger compartment as indicated by the microphone signal.

18. The method of claim 11 wherein the ascertaining comprises ascertaining the safety level based on a number of surrounding vehicles in the first images, a distance between at least one of the surrounding vehicles and the motor vehicle in the first images, whether the scene in the first images is backlit, locations of obstacles in the first images, and/or a number of obstacles in the first images.

19. The method of claim 11 further comprising:
selecting suitable output of vision/sound from very complex factor, not only brightness, loudness and carefulness but also more factors, for example temperature, humidity, the number of passengers in the car;
choosing a covariance matrix by age/sex/timeOfDriving; and
using the covariance matrix to convert a 4- or more dimensional vector to a two-dimensional vector, which indicates output of vision/sound.

20. A safety level presentation arrangement for a motor vehicle, comprising:
a camera configured to capture images of a driver of the motor vehicle within a passenger compartment of the motor vehicle;
a microphone associated with the passenger compartment and configured to produce a microphone signal dependent upon sounds within the passenger compartment;
a display device associated with the passenger compartment;
a loudspeaker associated with the passenger compartment; and
an electronic processor communicatively coupled to the camera, the microphone, the display device, and the loudspeaker, the electronic processor being configured to:
ascertain a safety level based on the images and traffic information wirelessly received from an external source; and
determine how to present the ascertained safety level to the driver by use of the display device and/or the loudspeaker, the determining being dependent upon the images and the microphone signal.
